(19) United States
(12) Patent Application Publication
(10) Pub. No.: US 2003/0086086 A1
(43) Pub. Date: May 8, 2003

(54) MOLDED BLOCK, AND MOLD AND METHOD FOR PRODUCTION THEREOF

(76) Inventor: RUSSELL L. KERSCHMANN, MILL VALLEY, CA (US)

Correspondence Address: MARY ROSE SCOZZAFAVA, CLARK & ELBING, 176 FEDERAL STREET, BOSTON, MA, 02110

(21) Appl. No.: 09/286,744

(22) Filed: Apr. 6, 1999

(51) Int. Cl. G01N 21/01

(52) U.S. Cl. 356/244

(57) ABSTRACT

A molded block, for holding a sample to be sectioned and examined, comprising a shank region integrally tapering to a specimen chamber having said sample embedded therein. The specimen chamber corresponds substantially to the cross-sectional size and shape of an imaging field of an imaging apparatus and may have a polygonal, for example, a rectilinear cross-sectional area. The shank region has a shape adapted for engagement with a securing means for securing the molded block to a sectioning instrument and for positioning the block face in an optimal orientation for imaging. A mold is provided for preparation of a molded block. The mold defines an elongated cavity, including an opening at a proximate end for introduction of a selected material from outside said mold. The proximate end defines a shape of a size and shape adapted for engagement with a securing means, and the mold tapers to a distal end that defines a polyhedron of a size and shape suitable for sectioning.

### BACKGROUND OF THE INVENTION

The preparation of organic tissue samples and other materials for transmission microscopy, both visible light and electron microscopy, is normally carried out by subjecting the sample to a series of chemical treatments culminating in the production of a solid block in which the sample is embedded.

In a conventional tissue preparation process, the tissue is first chemically fixed with formalin, glutaraldehyde, or other material which serves to preserve the sample from autolysis (self-degradation), to render the sample rigid, and to increase its permeability, thereby enhancing the infiltration of the subsequent solutions. The infiltration steps which follow chemical fixing remove all of the water from the sample through progressive replacement of water with increasing concentrations of solvents such as alcohol and xylene. Infiltration is followed by treatment with melted paraffin and the sample then is cooled to room temperature whereupon it solidifies. Alternatively, the tissue is infiltrated with plastic polymer that is then hardened by heat, ultraviolet light or other means. The hardened, infiltrated tissue is then position in a mold and surrounded with paraffin or plastic to produce a tissue block.

The current tissue preparation processes have been developed for standard light and electron microscopy, in which thin sections of the sample are cut from the block and transferred to glass slides or some other support. The tissue is stained to improve image contrast and then viewed under the microscope to give a two-dimensional image. Information about three-dimensional structures in the tissue is obtained by examining successive slices of the tissue.

U.S. Pat. No. 4,960,330 describes a block sectioning and image acquisition system in which successive sections are removed from the block and the emerging block faces are imaged using either a microscope or a scanning laser. The method provides rapid recording and storage of structure information without the time-consuming and error-prone handling of individual tissue sections. There has been little investigation into optimal geometries for the tissue block in viewing and recording visual data of the emerging block faces using this apparatus and method.

### SUMMARY OF THE INVENTION

One aspect of the invention is a molded block for holding a sample to be sectioned and examined. The molded block includes a shank region integrally tapering to a specimen chamber having the sample embedded therein. The specimen chamber has a cross-sectional geometry and is of a size and shape that corresponds substantially to the imaging field of an imaging apparatus used to image the block face. The shank region has a shape adapted for engagement with a securing means for securing the molded block to a sectioning instrument.

Another aspect of the invention is a mold for use in the preparation of a sample to be sectioned and examined. The mold defines an elongated cavity, including an opening at a proximate end for introduction of a selected material from outside the mold. The proximate end defines a shape adapted for engagement with a securing means. The mold tapers to a distal end which defines a polyhedron of a size and shape suitable for sectioning. The distal end of the mold also approximates the size and shape of an imaging field of an imaging apparatus which may be used to view an emerging face of a tissue block prepared from the mold.

In yet another aspect of the invention, a method of preparing a tissue sample for sectioning and examination is provided. The method includes embedding a sample in a specimen chamber of an elongated block comprising a shank region integrally tapering to the specimen chamber. The specimen chamber has a polygonal cross-sectional geometry and an exposed face which approximates the size and shape of an imaging field of an imaging apparatus used to view the sample. The shank region of the elongated block is then engaged with opposing surfaces of a securing means to secure the elongated block in a sectioning apparatus, wherein the specimen chamber is positioned to present a flat surface to a cutting means of the sectioning apparatus. A section of the tissue block is removed to expose a surface for examination. “Corresponding substantially to or approximating the imaging field of an imaging apparatus” means that the cross-section of the specimen chamber transverse to the length of the block, or the exposed surface of the sample chamber, approximates or is of similar size and shape as the imaging field of an imaging apparatus used to view the surface. The imaging field is the area over which an imaging device can record data which relates to the surface. It is desired that the exposed face of the block which is to be viewed be neither significantly larger nor smaller than the imaging field. The imaging device provides microscopic imaging of the surface, that is, the actual scale of the imaged area is not dictated by the scanning array but rather by the magnification optics. Thus the size of the imaging field is determined by the magnification optics and the shape of the imaging field is dictated by the array design.

The molds and molded blocks of the invention provide optimal performance during sectioning and imaging of an embedded tissue sample. The specimen chamber is of a dimension which maximizes image quality. By providing a specimen chamber having an exposed face that substantially corresponds to the area which can be captured by an imaging apparatus, the sample does not extend outside the viewing field (resulting in incomplete imaging), nor does the block face incompletely fill the imaging field which would result in unproductive imaging of empty space.

In addition, the specimen chamber geometry is independent from that of the shank. Thus, shank geometry can be selected to determine the specimen chamber position relative to the knife so as to produce high quality exposed surfaces on the block face.

### BRIEF DESCRIPTION OF THE DRAWING

The invention is described with reference to the following Figures which are presented for the purpose of illustration only and are in no way limiting of the invention, and in which:

FIG. 1 is a perspective drawing of a mold of the invention;

FIGS. 2 A-C are perspective views of three molded blocks of the invention;

FIGS. 3 A-C are cross-sectional views of the shank region of the molded block having various cross-sectional geometries shown engaged with a securing means of a sectioning apparatus;

FIG. 4 is side view a mold of the invention, including a threaded cap; and

FIG. 5 is (a) top view and (b) a bottom view of a mold of the invention.

### DESCRIPTION OF THE PREFERRED EMBODIMENTS

The molded block of the invention is intended for use in a sectioning apparatus, such as a microtome, which is capable of removing successive sections from the block. A sectioning apparatus typically includes a reciprocating bar supporting a tissue block holder and a knife holder with a blade. The reciprocating bar moves the tissue holder (and the molded block secured thereto) up and down and advances the molded block towards the blade to remove a section of the block. When the molded block is used in conjunction with the automated image recording apparatus described in U.S. Pat. No. 4,960,330, which is incorporated in its entirety by reference, the tissue sections cut from the block are discarded and the exposed face of the block is examined. The microtome is positioned on a base which also supports an imaging apparatus for viewing the exposed face of the block.

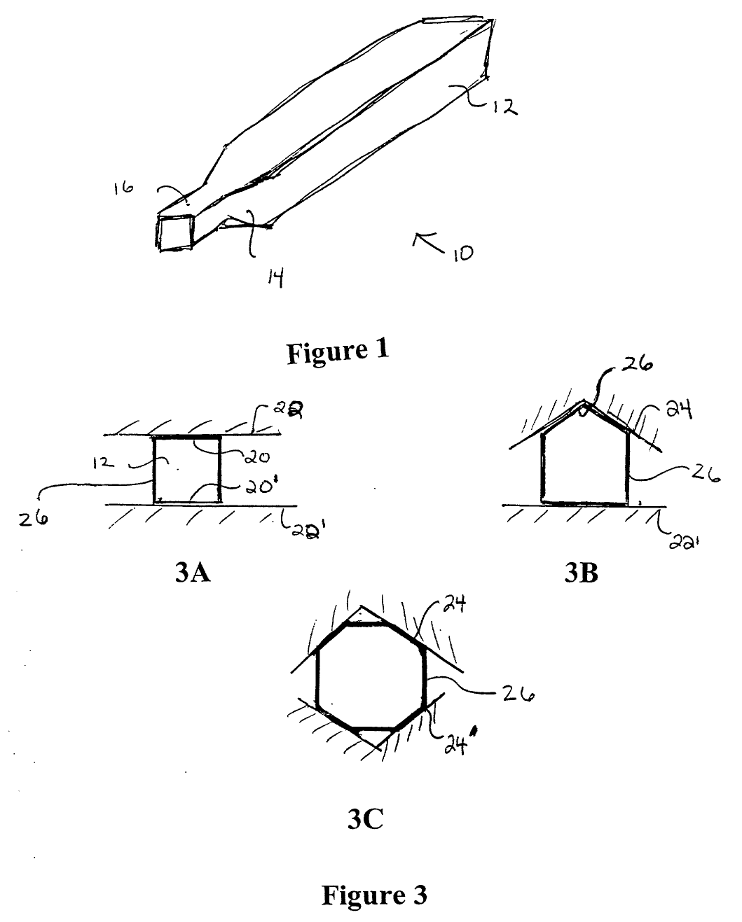

The molded block of the invention includes a shank region integrally tapering to a specimen chamber in which each feature is specifically adapted for its particular purpose. With reference to FIG. 1, the molded block 10 includes a shank region 12 which is of a size and shape suitable to be engaged with a securing means (not shown) for securing the block to a sectioning instrument for sectioning and/or examination. The shank region 12 tapers at a transitional region 14 to a specimen chamber 16. The specimen chamber is of a size and dimension suitable for positioning a tissue sample therein and for sectioning in a sectioning instrument (not shown). The size and shape of the specimen chamber also corresponds substantially to an imaging field of an imaging apparatus (not shown) used in the examination of the block face. The shank region 12 is of a size and dimension that permits it to be tightly held by the securing means and that provides mechanical strength and rigidity to the block. Mechanical strength is desired to prevent bending and vibrations during sectioning of the specimen chamber.

Typical imaging apparatuses which can be used in the imaging of the molded block of the invention include area array and linear charge coupled devices (CCDs). A CCD is a detector that provides digital images. The digital format allows the images to be manipulated by a computer, which can electronically modify or copy them. Electronic storage and editing of images provide significant advantages over conventional photographic methods.

The viewing field of an area array scanner is a rectilinear area defined by a two-dimensional array of pixels. The greater the number of pixels defining the image, the greater the resolution. A low resolution area array CCD may have dimensions of 300×600 pixels, while higher resolution CCDs have dimensions on the order of 2000×2000 pixels. A linear CCD scanner has only one row of pixels. A complete image is obtained by incrementally advancing the linear CCD (or the sample) as the scanner moves across the width of the sample. In both case, the imaging field defines a rectilinear area. Rarely, non-retilinear CCDs may be employed.

The selection of the size and shape of the specimen chamber is made with consideration of the type of imaging apparatus used to capture the images from the exposed face of the block. Thus, the specimen chamber shape is selected to avoid empty space in the imaging area or extension of the sample outside the imaging area. These circumstances are to be avoided where possible because they reduce the amount of digital data (pixels) that correspond to the tissue sample. The greater the pixel number defining the sample (as compared to the empty space), the greater the resolution. Thus, by minimizing background in the imaging field, imaging resolution of the sample is improved.

In a preferred embodiment, the specimen chamber has a square cross-section. In another preferred embodiment, the specimen chamber has a rectangular or a trapezoidal cross-sectional geometry. A trapezoidal cross-section in which the longer edge of the trapezoid is presented to the knife during sections produces surfaces of particularly high quality.

In a less preferred embodiment, the specimen chamber may be circular or a polygon which approaches circularity. Such a specimen chamber is suited for use with round tissue samples to closely match the specimen chamber with the tissue sample size and shape. Thus, any shape which can accommodate the tissue to be imaged within an imaging field is within the scope of the present invention.

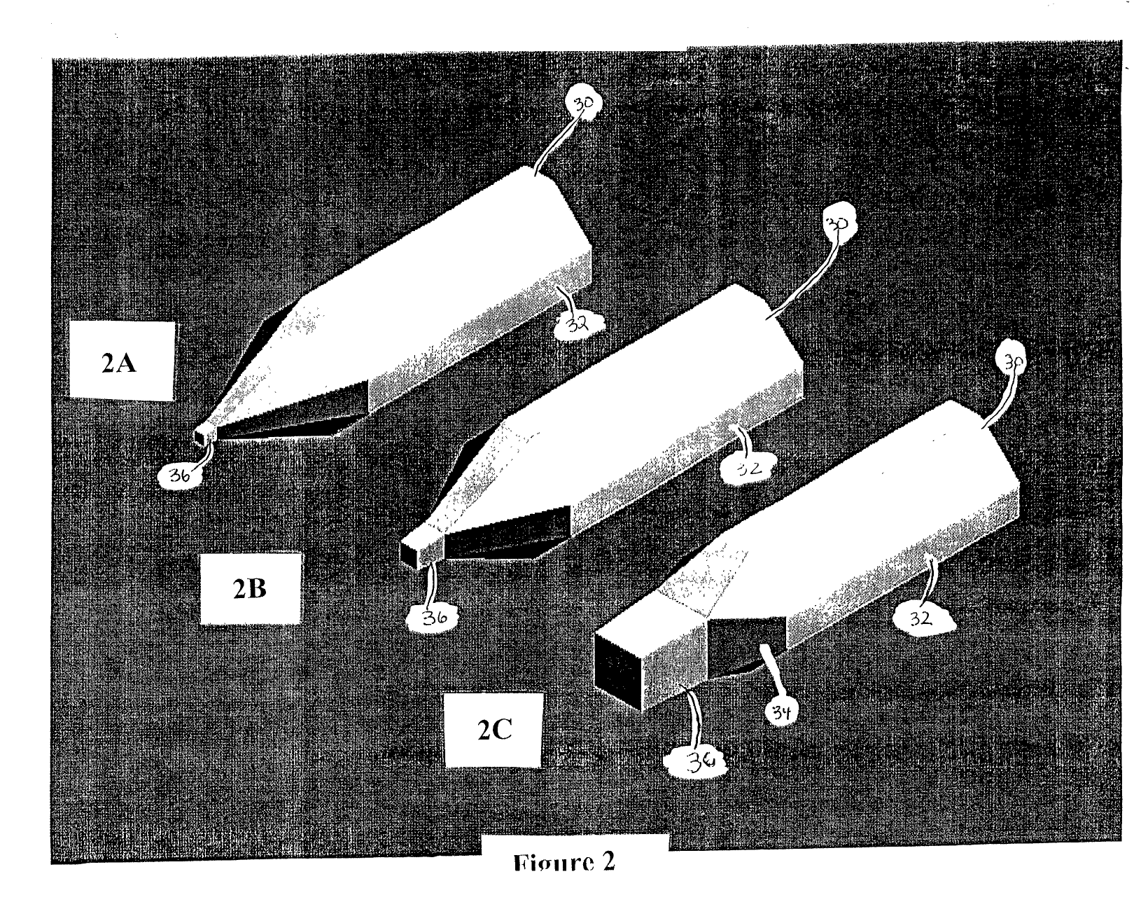

Molded blocks of varying specimen chamber sizes are provided as are shown in FIGS. 3A-C. For most purposes, a specimen chamber of square or slightly rectangular cross-section is appropriate. A suitable block is selected based on tissue sample size and optimal imaging geometry. For example, a punch biopsy of the skin may produce a round skin sample of about 4 mm in diameter. A 4.5 mm×4.5 mm square specimen chamber could easily accommodate such a sample, while still corresponding substantially to the imaging field of a CCD scanner.

When the sample is of an irregular shape, the shape of the specimen chamber may be selected accordingly. For example, a prostate needle biopsy produces a sample that is approximately 1 mm in diameter and 17 mm in length. A preferred specimen chamber for such a tissue sample would possess that shape as well, for example, by having a rectangular cross-section with dimensions of about 2 mm across and 20 mm long. In such cases, a linear CCD scanner may be used to generate a rectangular imaging field.

Although the quality of a section cut from such a long thin block face may be less than optimal for examination with conventional microscopy techniques, the quality of the exposed, cut face is unaffected. Thus, when the molded block is used in conjunction with the automated image recording apparatus of U.S. Pat. No. 4,960,330, a wide variety of shapes of the specimen chamber not heretofore considered suitable for tissue imaging can be employed in order to obtain high quality imaging area.

In preferred embodiments, the specimen chamber has a flat presenting edge parallel to the knife, blade or other cutting means when mounted in a sectioning apparatus. Thus, positioning the specimen chamber so as to present a corner (the meeting of two surfaces) to the blade is to be avoided because these geometries and orientations do not present a flat edge to the blade. It is also understood that surface irregularities or jaggedness are undesirable as they impede the presentation of a flat edge to the blade in the use of the molded block.

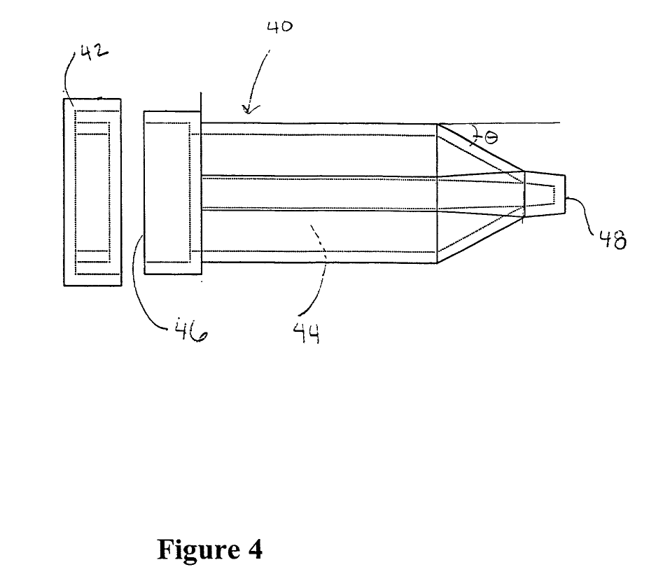

Thus, the polygon defining the specimen chamber desirable possesses an edge which can be presented parallel to the knife or blade during sectioning. Note, however, that the polyhedron surfaces defining the volume of the specimen chamber need not have opposing parallel faces. This is shown clearly in the mold used to prepare the molded blocks in FIG. 4. Such non-parallel tapering surfaces may be selected so that the block may more easily be removed from a mold in which it is cast.

The specimen chamber may be of any dimension which accommodates a sample to be examined. The specimen chamber may range from dimensions on the order of millimeters, e.g., 2 mm×2 mm, to as large as tens of centimeters, e.g., 60 cm×60 cm and most typically in the range of 0.5 mm to 2 cm on a side. The limiting factors are only that suitable sectioning and imaging apparatus be available for integration with the molded block of the invention.

The shank region of the molded block is used to firmly secure the block to a sectioning apparatus and to maintain the block in the proper orientation for cutting and imaging the sample. Securing means of the sectioning apparatus typically have opposing surfaces which are capable of movement into and out of engagement with the shank region of the molded block. Securing means are any conventional element used to secure or fix an object to a surface, such as a vise, clamp, clasp, fastener, jaws, chuck, brace, and the like. The opposing surfaces of the securing means may be flat or notched surfaces or otherwise modified to engage with the shank region of the molded block.

In one embodiment, the shank region possesses parallel flat surfaces 20,20′ which are engaged by opposing flat surfaces 22,22′ of the securing means, as is illustrated in the cross-sectional view of the shank in FIG. 3A. In another embodiment, the shank is designed to be engaged by one or two notched surfaces, 24, 24′, as are shown in FIGS. 3B and 3C, respectively. In these cases, the shank region is of a shape which permits engagement with a securing means in order to rigidly anchor the block to the apparatus. For example, the notched surfaces may engage with a comer 26 of the molded block, such as is illustrated in FIG. 3B. The notch may be somewhat smaller than the shank so that there is a separation or gap between the upper and lower surfaces of the securing means. The shank region may be of any shape that has flat surfaces to rigidly secure it to the sectioning apparatus. An alternative embodiment is shown in FIG. 3C using two opposing notched surfaces to engage an octagonally shaped shaft. The present invention does not require all surfaces to be flat, however. For example, surfaces 26 which are not engaged with the securing means may be curved.

In a preferred embodiment, the shank region possesses an octagonal cross-sectional geometry. Even more preferred, the shank region possesses an irregular octagonal cross-sectional geometry. By “irregular geometry” is meant that the sides of the polygon defining the cross-section of the block are not of equal length. For example, an irregular octagon includes an octagon having alternating short and long sides, e.g., four short sides and four long sides. By selecting an irregular polygon as the cross-sectional geometry of the shank, one is able to distinguish between otherwise equivalent surfaces. Other irregular geometries, such as irregular hexagons or decagons and the like, are contemplated as within the scope of the invention.

FIGS. 2 A-C are perspective illustrations of three molded blocks of the invention. Each of the molded blocks 30 includes an irregular octagonal shank region 32 which tapers in a transitional region 34 into a square or rectangular specimen chamber 36. As is illustrated in FIGS. 3 A-C, the size of the specimen chamber can vary greatly and is desirably selected to substantially correspond to the size and shape of the imaging filed used in viewing the sample.

The length of the taper and degree of the taper in the transitional region may be varied, as is demonstrated in FIG. 2. The taper may be in either direction, with the shank larger than the specimen chamber or vice versa. The taper may be selected so that the ratio of specimen chamber:shank cross-sections ranges from about 4-to-1 to 1-to-20. In preferred embodiments, the specimen chamber: shank ratio is less than 1 and preferably about 1:10.

In preferred embodiments, the taper is gradual to facilitate insertion of the tissue sample into the tip of the specimen chamber. The taper angle is defined by surface planes of the shank and of the transitional region. The taper angle θ is shown in FIG. 4. Taper angle θ is preferably less than 60°, and preferably less than 45° and may be as small as 10°. A tissue sample is typically deposited in the specimen chamber of the molded block by gravitational settling or by centrifuging the sample into the base of a mold. At smaller taper angles, the taper is more gradual and it reduces the tendency of a tissue sample to get caught on the mold walls during the embedding operation.

Use of an irregular geometry, such as the irregular octagon shown in FIG. 2, assures that a straight edge of the specimen chamber is always presented to a blade when the molded block is placed in the sectioning apparatus and that the block face is in the proper orientation for imaging. By way of explanation, there are eight possible orientations of the block at the shaft end, but only four optimal orientations (in the case of a square block face) of the specimen chamber. A rectangular block face would have only two optimal orientations and the shank geometry may be adjusted, accordingly. Certain of the shaft orientations undesirably result in a diagonal orientation for the specimen chamber in which a comer is presented to the blade and in which the block face does not coincide with the imaging field. In contrast, an irregular octagon possesses only four equivalent orientations, which correspond to the four orientations of the specimen chamber. Thus, it is possible to easily select the appropriate orientation of the shank when securing the molded block into the sectioning apparatus so that a straight edge is presented to the blade for sectioning. It should be readily apparent that the use of irregular polygons is not limited to the octagonal molded block shown in FIG. 2. Irregular polygons may be used for any shape specimen chamber. For example, in irregular decagonal shaft may be used in conjunction with a pentagonal specimen chamber.

The length of the molded block is not critical. In general, the shank is of a length that permits its solid engagement in the clamp or vise. In preferred embodiments, the shank does not extend significantly from the clamp, as the length contributes to bending and breaking of the molded block during cutting. It is desirable, but not required, that the shank length extending beyond the clamp be no more than three-five times the length of specimen chamber. Typical overall lengths of the molded blocks range from two to five centimeters. Actual lengths will depend on the thickness of the molded block and materials used in making the molded block.

The molded block is prepared by introducing an embedding material into a mold of the appropriate shape. The molded block may be made from any material conventionally used to prepare embedded tissue samples, such as by way of example, paraffin, glycol methacrylate and epoxy resin. The mold may further comprise identification means, such as a label or an identification integral with the mold.

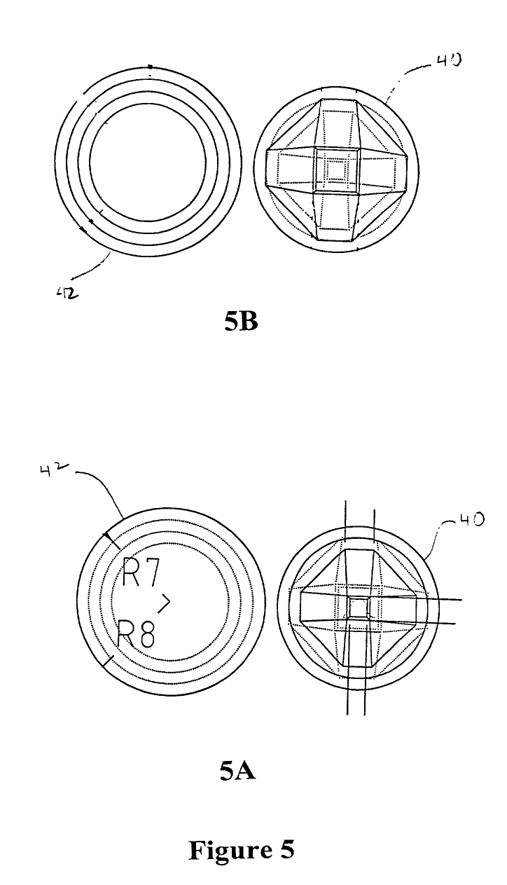

An exemplary mold is shown in FIG. 4. FIG. 4 is a side view of a mold 40, including a leak-proof cap 42. While a cap is not required, it may be necessary if the mold is also to serve as a vessel for transportation of a sample in liquid fixative. FIGS. 5A and 5B are top and bottom views, respectively, of the mold and cap. The mold incorporates the features described herein above for the molded block. The mold 40 defines an elongated cavity 44, including an opening at a proximate end 46 for introduction of a selected material from outside said mold. The proximate end 46 also defines a shape of a size and shape adapted for engagement with a securing mean. The mold tapers to a distal end 48 and the distal end defines a polyhedron of a size and shape suitable for sectioning. In preferred embodiments, the mold is threaded so that cap 42 may be used to close the mold. Alternatively, snap-on caps or other leak-proof caps may be used.

The mold may be prepared from any conventional material, for example, polypropylene, silicone and polystyrene. Selection of the material may be influenced, in part, by the intended use of the mold. The molds may be reusable or sacrificial. Reusable molds are prepared from flexible materials such as silicone. Sacrificial molds include molds which remain on the molded block during sectioning operations and molds which are destructively removed from the molded block. In the instance where the mold is intended to be removed, the sacrificial molds desirably are prepared using materials that fracture or tear easily. Suitable materials include polypropylene. In the instance where the mold is intended to be carried through the cutting process, the mold desirably is prepared from rigid or sturdy material that lends itself to being cut. Suitable materials include polystyrene.

A tissue sample is embedded into the molded block using standard embedding methods. Thus, for example, the tissue is first chemically fixed with standard fixative liquids to preserve the sample from autolysis (self-degradation), to render the sample rigid, and to increase its permeability, thereby enhancing the infiltration of the subsequent solutions. Thereafter, the water from the sample is removed through progressive replacement of water with increasing concentrations of solvents such as alcohol and xylene. Infiltration is followed by treatment with melted paraffin or with plastic polymer to produce a hardened infiltrated tissue. The preceding steps may be carried out in the mold or in other appropriate containers. The hardened, infiltrated tissue is then positioned in the specimen chamber of the mold and is surrounded with paraffin or plastic to produce a tissue block.

The tissue block of the present invention may be used in conjunction with any conventional microscopic tissue preparation techniques. For example, the present invention may be used in conjunction with the stains and embedding polymers described in co-pending application U.S. Ser. No. 09/154,430, entitled “Histologic Processing of Tissue and Other Material”, which is hereby incorporated in its entirety by reference.

To image the molded block, the block is secured to a sectioning apparatus, such as a microtome, and successive sections of the block are removed. A sectioning apparatus typically includes a reciprocating bar supporting a tissue block holder and a knife holder with a blade. The reciprocating bar moves the tissue holder (and the molded block secured thereto) up and down and advances the molded block towards the blade to remove a section of the block. When the molded block is used in conjunction with the automated image recording apparatus described in U.S. Pat. No. 4,960,330, the tissue sections cut from the block are discarded and the exposed surface of the block is examined. An image may be captured according to conventional means, such as using a digital array camera or a linear CCD in which a line sensor is scanned across the block face.

What is claimed is:

1. A molded block, for holding a sample to be sectioned and examined, comprising a shank region integrally tapering to a specimen chamber having said sample embedded therein;
the specimen chamber having a cross-sectional geometry and being of a size and shape that corresponds substantially to an imaging area of an imaging apparatus and the shank region having a shape adapted for engagement with a securing means for securing the molded block to a sectioning instrument and to present the specimen chamber in a proper orientation for imaging.

2. The molded block of claim 1 wherein the specimen chamber has a polygonal cross-sectional geometry and is of a size and shape suitable for sectioning.

3. The molded block of claim 1 wherein the specimen chamber is of a size and shape corresponding to the imaging field of an area array scanner.

4. The molded block of claim 1 wherein the specimen chamber is of a size and shape corresponding to the imaging field of an linear charged couple device (CCD) scanner.

5. The molded block of claim 1, wherein the shape of the specimen chamber and the shank are dissimilar.

6. The molded block of claim 1, wherein the cross-sectional geometry of the specimen chamber is rectangular.

7. The molded block of claim 1, wherein the cross-sectional geometry of the specimen chamber is square.

8. The molded block of claim 1, wherein the shank is of a shape capable of engaging opposing parallel surfaces.

9. The molded block of claim 1, wherein the shank is of a shape capable of engaging a flat surface and an opposing notched surface.

10. The molded block of claim 1, wherein the shank is of a shape capable of engaging opposing notched surfaces.

11. The molded block of claim 1, wherein the shank has an octagonal cross-sectional geometry.

12. The molded block of claim 1 wherein the ratio of the specimen chamber diameter to shank diameter is in the range of about 4:1 to about 1:20.

13. The molded block of claim 11, wherein the octagon of the octagonal cross-section is an irregular octagon.

14. The molded block of claim 1 wherein the relative orientation of the specimen chamber and the shank is selected such that when the shank region is secured in a sectioning apparatus, the specimen chamber presents a flat edge to a blade.

15. The molded block of claim 1, wherein the molded block has a taper angle of less than about 60 degrees.

16. The molded block of claim 1, wherein the molded block has a taper angle of less than about 45 degrees.

17. A mold for use in the preparation of a sample to be sectioned and examined, comprising:
a mold defining an elongated cavity, including an opening at a proximate end for introduction of a selected material from outside said mold,
wherein the proximate end defines a shape adapted for engagement with a securing means, and
wherein the mold tapers to a distal end, the distal end defining a polyhedron of a size and shape corresponding substantially to an imaging field of an imaging apparatus the cavity and the polyhedron arranged to present the distal end in a proper orientation for imaging.

18. The mold of claim 17, wherein the mold is sacrificial.

19. The mold of claim 17, wherein the mold is reusable.

20. The mold of claim 17, wherein the mold farther comprises a cap at the proximate end.

21. The mold of claim 17, wherein the proximate end of the mold and the cap are threaded.

22. The mold of claim 17, wherein the shapes defined by distal and proximal ends of the mold are dissimilar.

23. The mold of claim 17, wherein the mold further includes identification means.

24. The mold of claim 17, wherein the distal end of the mold defines a rectangular polyhedron.

25. The mold of claim 17, wherein the distal end of the mold defines a cube.

26. The mold of claim 17, wherein the proximal end of the mold defines a shape capable of engaging opposing parallel surfaces.

27. The mold of claim 17, wherein the proximal end of the mold defines a shape capable of engaging a flat surface and an opposing notched surface.

28. The mold of claim 17, wherein the proximal end of the mold defines a shape capable of engaging opposing notched surfaces.

29. The mold of claim 17, wherein the proximal end of the mold has an octagonal cross-sectional geometry.

30. The mold of claim 17, wherein the octagon of the octagonal cross-section is an irregular octagon.

31. The method of claim 17, wherein the mold has a taper angle of less than about 60 degrees.

32. The method of claim 17, wherein the mold has a taper angle of less than about 45 degrees.

33. A method of preparing a tissue sample for sectioning and examination, comprising:
embedding a sample in a specimen chamber of an elongated block, said block comprising a shank region integrally tapering to the specimen chamber, the specimen chamber having a polygonal cross-sectional geometry and being of a size and shape corresponding substantially to an imaging field of an imaging apparatus;
engaging the shank region of the elongated block with opposing surfaces of a securing means to secure the elongated block in a sectioning apparatus, wherein the specimen chamber is positioned to present a flat surface to a cutting means of the sectioning apparatus and to present the proper orientation for imaging; and
removing a section of the tissue block to expose a surface for examination.

34. The method of claim 33, wherein;
the tissue block is encased in a mold.

35. The method of claim 33, wherein the tissue block is sectioned as a mold-encased block.

36. The method of claim 33, further comprising:
imaging the exposed surface of the tissue block.
